(19) United States
(12) Patent Application Publication
(10) Pub. No.: US 2015/0268911 A1
(43) Pub. Date: Sep. 24, 2015

(54) IMAGE FORMING SYSTEM AND IMAGE FORMING DEVICE

(71) Applicant: Oki Data Corporation, Tokyo (JP)

(72) Inventor: Hideki SATO, Tokyo (JP)

(21) Appl. No.: 14/665,056

(22) Filed: Mar. 23, 2015

(30) Foreign Application Priority Data
Mar. 24, 2014 (JP) 2014-059465

(51) Int. Cl. G06F 3/12

(52) U.S. Cl. CPC G06F 3/1292; G06F 3/1204; G06F 3/1268; G06F 3/126; G06F 3/1253; G06F 3/1238; G06F 3/1288; G06F 3/1294

(57) ABSTRACT

In a cloud computing system with multiple image forming devices, an image forming device on which an operation is performed sends the cloud server operation information indicating that the operation has been performed. The cloud server generates screen data for a screen listing the image forming devices and indicating the image forming device on which the operation was performed, and sends the screen data to an information processing device. The information processing device displays this screen, enabling the user of the information processing device to easily identify the image forming device on which the operation was performed and thereby select the right image forming device to use.

### BACKGROUND OF THE INVENTION

1. Field of the Invention

This invention relates to an image forming system and an image forming device.

2. Description of the Related Art

Systems with a cloud printing function that enables users to log into a plurality of printers connected to a network and have printing performed by the printers already exist. To improve the security of such systems, a method of using the user ID of a logged-in user who executes printing to lock the user's client device while the printing is in progress is disclosed by Yamazaki in Japanese Patent Application Publication No. 2012-123627.

### SUMMARY OF THE INVENTION

Use of the cloud printing function enables printing to be executed from a mobile client device such as a mobile information device, so the user can go to the printer and execute the printing job from a position close to the printer. When a plurality of printers are registered in the cloud, however, it can be difficult to tell which of the printers displayed by the mobile information device is the printer being used to print by the user just now.

The purpose of the present invention is to enable easy identification of the printer or other image forming device to be used from among a plurality of image forming devices registered in a system.

The invention provides an image forming system including a plurality of image forming devices, a management server, and an information processing device.

In some embodiments of the invention, each of the image forming devices includes an operation unit for accepting an operation, a first control unit for generating operation information indicating that the operation accepted by the operation unit has been carried out, and a first transmitting unit for sending the operation information generated by the first control unit to the management server.

The management server includes a second receiving unit for receiving the operation information sent from the first transmitting unit, a second control unit for generating screen data for a list display screen listing the plurality of image forming devices, and a second transmitting unit for sending the screen data generated by the second control unit to the information processing device. The list display screen includes a displayed indication that the operation indicated by the operation information has been carried out on the image forming device from which the operation information was sent.

The information processing device includes a designating unit for designating image forming data, a third receiving unit for receiving the screen data sent from the second transmitting unit, a display unit for displaying the list display screen on a basis of the screen data received by the third receiving unit, and an accepting unit for accepting a selection that selects, from the list display screen, an image forming device to form an image based on the image forming data designated by the designating unit.

The second transmitting unit sends the image forming data designated by the designating unit to the image forming device selected by the accepting unit.

Each of the image forming devices also includes a first receiving unit for receiving the image forming data sent from the second transmitting unit, and an image forming unit for forming an image based on the image forming data received by the first receiving unit.

The displayed indication makes it easy to identify the image forming device to be used from among a plurality of image forming devices registered in a system.

### BRIEF DESCRIPTION OF THE DRAWINGS

In the attached drawings:

FIG. 1 is a block diagram schematically illustrating the configuration of an image forming system according to an embodiment of the invention;

FIG. 2 is a block diagram schematically illustrating the configuration of a printer in the embodiment;

FIG. 3 schematically shows exemplary user information used in the embodiment;

FIG. 4 schematically shows exemplary device information used in the embodiment;

FIG. 5 is a block diagram schematically illustrating the configuration of a cloud server in the embodiment;

FIG. 6 is a block diagram schematically illustrating the configuration of a mobile information device in the embodiment;

FIG. 7 is a flowchart illustrating the process of registering a printer in the cloud server in the embodiment;

FIG. 8 schematically shows a first exemplary printer list display screen giving printer information used in the embodiment;

FIG. 9 is a flowchart illustrating the process of logging into a printer in the embodiment;

FIG. 10 schematically shows a second exemplary printer list display screen giving printer information used in the embodiment;

FIG. 11 schematically shows an example of printer setting information used in the embodiment;

FIG. 12 is a flowchart illustrating the process of executing printing on a printer in the embodiment;

FIG. 13 is a flowchart illustrating the process of logging out from a printer in the embodiment;

FIG. 14 is a flowchart illustrating a process carried out when a button is pressed in the embodiment; and

FIG. 15 schematically shows a third exemplary printer list display screen giving printer information used in the embodiment.

### DETAILED DESCRIPTION OF THE INVENTION

An embodiment of the invention will now be described with reference to the attached drawings, in which like elements are indicated by like reference characters.

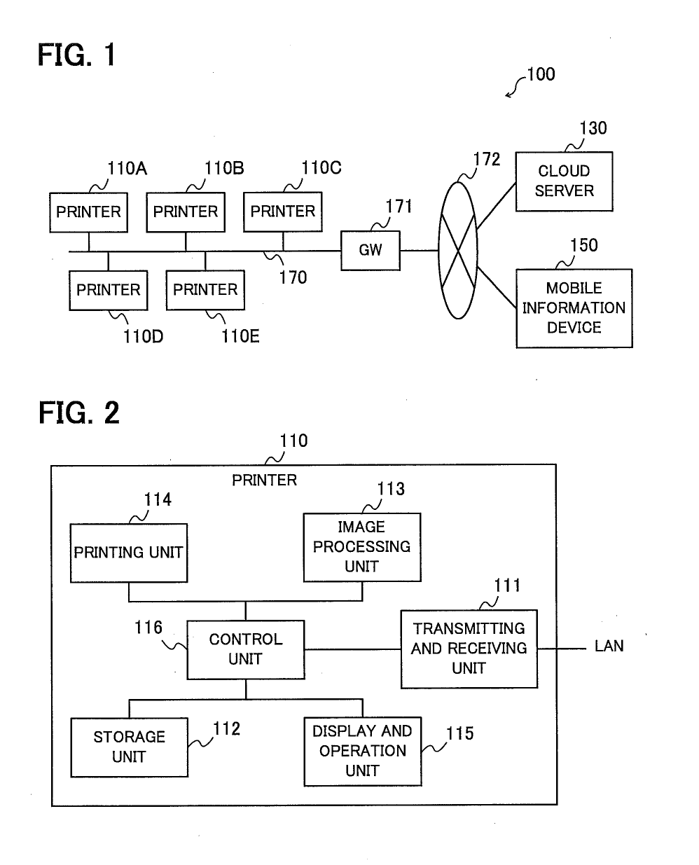

Referring to the block diagram in FIG. 1, the image forming system 100 in the embodiment includes printers 110A-110E used as image forming devices, a cloud server 130 used as a management server, and a mobile information device 150 used as an information processing device. For simplicity, each of the printers 110A-110E will be referred to below as a printer 110.

The printers 110 are connected to a local area network (LAN) 170, and then through a gateway (GW) 171 to the Internet 172. The cloud server 130 and the mobile information device 150 are connected to the Internet 172. The way in which the printers 110, cloud server 130, and mobile information device 150 are interconnected is not limited to the example shown, provided they can send data to each other and receive data from each other.

Referring to the block diagram in FIG. 2, each printer 110 has a transmitting and receiving unit 111, a storage unit 112, an image processing unit 113, a printing unit 114, a display and operation unit 115, and a control unit 116.

The transmitting and receiving unit 111 functions as a transmitting unit (a first transmitting unit) that transmits data and a receiving unit (a first receiving unit) that receives data. For example, the transmitting and receiving unit 111 may be connected to the LAN 170, and may transmit data to and receive data from the LAN 170. The transmitting and receiving unit 111 may be, for example, a network interface card (NIC).

The storage unit 112 stores information needed in processing by the printer 110. For example, the storage unit 112 stores the printer name, its device identifier (ID), setting information, printing setting information (image forming setting information), printing data (image forming data), and user list information.

The printer name and device ID constitute image forming device identification information for identifying the printer 110. The printer name is the name by which the user recognizes the printer in the cloud service. The device ID is identification information for uniquely identifying the printer 110.

The setting information is a list of image forming settings (printing settings) supported by the printer 100. The user can select the settings in the setting information at the time of image formation (printing). The setting information covers such image forming properties (printer properties) as availability of color printing, available paper trays, the number of copies that can be printed, duplex printing, and so on.

The printing setting information indicates the printing settings selected by the user when printing is executed, which are sent from the cloud server 130 and received by the transmitting and receiving unit 111.

The printing data are image forming data sent from the cloud server 130 and received by the transmitting and receiving unit 111.

The user list information includes user identification information for identifying users of the printer 110, authentication information for authenticating the users, and permission information indicating what privileges the users have.

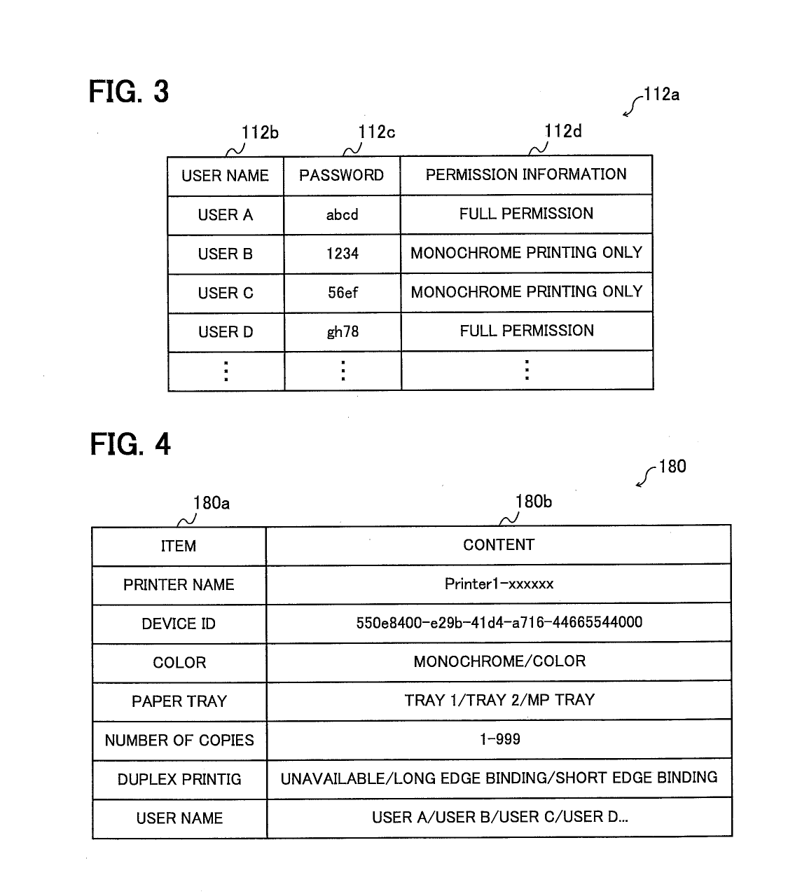

FIG. 3 shows exemplary user list information 112a having a user name column 112b, a password column 112c, and a permission information column 112d.

The user name column 112b stores user names as user identification information for identifying users of the printer 110.

The password column 112c stores passwords as authentication information for authenticating the users identified in the user name column 112b.

The permission information column 112d stores permission information as privilege information indicating what privileges the users identified in the user name column 112b have. The permission information indicates what printing methods the users identified in the user name column 112b are allowed to use. For example, a user identified in the user name column 112b whose permission information is ‘full permission’ has all permissions and can select any of the settings that can be made on the printer for his or her printing jobs. If the permission information is ‘monochrome only’, the user identified in the user name column 112b can use the printer 110 for monochrome printing but not for color printing.

Returning to FIG. 2, the image processing unit 113 converts printing data stored in the storage unit 112 to printing data (image forming data) for the printer 110 on the basis of the printing setting information stored in the storage unit 112.

The printing unit 114 is an image forming unit that prints (forms an image) on paper or other media on the basis of the printing data that have been processed by the image processing unit 113.

The display and operation unit 115 functions as an operation unit that accepts operations from the user and as a display unit that displays information on a screen. The display and operation unit 115 has, for example, buttons that the user can operate. The buttons may be located on the screen displayed by the display and operation unit 115.

The control unit 116 controls the above units to carry out processes in the printer 110. For example, on the basis of information stored in the storage unit 112, the control unit 116 generates device information to be registered in the cloud server 130. The control unit 116 caused the transmitting and receiving unit 111 to send the generated device information to the cloud server 130.

Exemplary device information is shown schematically in FIG. 4. The device information 180 includes an item column 180a and a content column 180b.

The item column 180a stores item names as item identification information for identifying items to be reported to the cloud server 130. In this embodiment, the items to be reported to the cloud server 130 are the printer name, the device ID, color, paper tray, number of copies, duplex printing, and user name.

The content column 180b stores content (values) corresponding to the items identified in the item column 180a. The content of the ‘printer name’ item, for example, is the printer name stored in the storage unit 112. The content of the ‘device ID’ is the device ID stored in the storage unit 112. The content of the ‘color’, ‘paper tray’, ‘number of copies’, and ‘duplex printing’ items is specified by the setting information stored in the storage unit 112. These items are settings that the user can select when printing is carried out by the printer 110. The content of the ‘user name’ item is the user names of users who may use the printer. All of the user names stored in the user name column 112b of the user list information 112a (see FIG. 3) are stored in the content column 180b of the ‘user name’ item.

Returning again to FIG. 2, when a predetermined operation is carried out on the display and operation unit 115, the control unit 116 generates operation information indicating that this operation has been performed. In the description of this embodiment, the predetermined operation is a log-in operation, but this is only one example and is not limiting. The control unit 116 has the transmitting and receiving unit 111 send the generated operation information to the cloud server 130. In the operation information, the control unit 116 includes at least the printer name and printer ID that identify the printer 110, and may also include the user name of the user who performs the operation.

At predetermined times the control unit 116 also generates operation termination information. In the description of this embodiment, operation termination information is generated when the printer 110 transits from the logged-in state to the logged-out state, but this is also a non-limiting example. The control unit 116 has the transmitting and receiving unit 111 send the generated operation termination information to the cloud server 130. In the operation termination information, the control unit 116 includes at least the printer name and printer ID that identify the printer 110.

In the configuration described above the printer 110 is connected to the Internet 172 through the LAN 170, but this is again a non-limiting example. Whatever connection configuration is possible, provided the printer 110 can may connect up the Internet 172.

One or more unit in the printer 110 may be implemented by a processor such as a CPU (Central Processing Unit). For example, the image processing unit 113 and the control unit 116 may be implemented by the CPU executing a predetermined program. The storage unit 112 may be implemented by a memory controlled by the CPU.

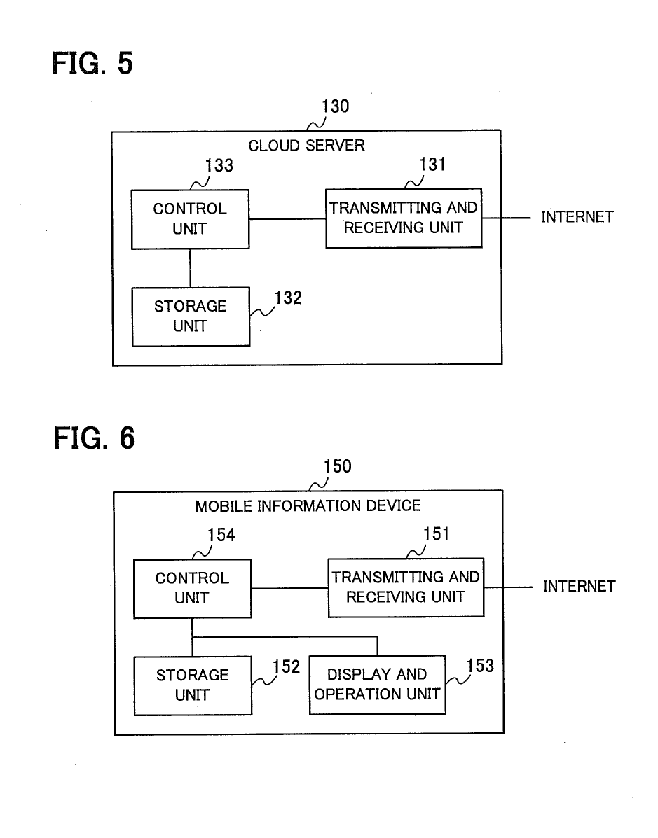

Referring now to the block diagram in FIG. 5, the cloud server 130 includes a transmitting and receiving unit 131, a storage unit 132, and a control unit 133.

The transmitting and receiving unit 131 functions as a transmitting unit (a second transmitting unit) that transmits data and a receiving unit (a second receiving unit) that receives data. For example, the transmitting and receiving unit 131 may be connected to the Internet 172, and may transmit data to and receive data from the Internet 172. The transmitting and receiving unit 131 may be, for example, an NIC.

The storage unit 132 stores information needed in processes carried out by the cloud server 130. For example, the storage unit 132 stores the device information 180 sent from a printer 110, as well as storing printing jobs, log-in information, management information, and status management information.

Log-in information is authentication information used for logging into the cloud server 130. For example, the user's account registered in the cloud server 130 and the mail address of the mobile information device 150 or other information processing device used by the user may be used as log-in information.

The management information identifies the printers 110 that a user registered in the cloud server 130 may use. For example, the printer names and device IDs of the printers used by a user registered in the cloud server 130 may be stored in association with the user's account registered in the cloud server 130 and mail address. A plurality of users registered in the cloud server 130 may be designated as a group, in which case a printer 110 associated with any user in the group may also be used by the other users in the group. When groups of this type are formed, the management information also includes the groups to which a user belongs.

The status management information is information used to manage the status of the printers 110 registered in the cloud server 130. For example, the status management information may be information associating the printer name and device ID of a printer 110 registered in the cloud server 130 with the status reported by this printer 110. When the operation information sent from the printer 110 indicates that an operation has been performed, this also becomes part of the printer's status.

By controlling the above units, the control unit 133 carries out various processes in the cloud server 130. The processes carried out include, for example, registering a printer 110 and storing management information associating the information forming device identification information included in the device information sent from a printer 110 that is being registered with input accounts and mail addresses.

The control unit 133 also executes the cloud printing function, using the printers 110. In doing so, the control unit 133 generates screen data for a display screen listing the printers 110, so that a printer 110 can be selected for cloud printing. The status of the printers 110 is indicated in this list display screen. For a printer 110 that has sent operation information, the list display screen includes an indication that the operation indicated by the operation information has been carried out on the printer 110. The control unit 133 has the transmitting and receiving unit 131 send this screen data to the mobile information device 150. The control unit 133 also has the transmitting and receiving unit 131 send printing data designated by the mobile information device 150 to a printer 110 selected from the mobile information device 150.

When operation information is sent from a printer 110, the control unit 133 updates the status associated, in the status management information stored in the storage unit 132, with the printer name and printer ID included in the operation information to indicate that the operation included in the operation information has been carried out. When operation termination information is sent from a printer 110, the control unit 133 deletes (or updates) the status associated, in the status management information stored in the storage unit 132, with the printer name and printer ID included in the operation termination information.

The cloud server 130 described above may be implemented by a computer incorporating a CPU, a memory, an external storage device such as HDD (Hard Disk Drive), an input device such as a keyboard and a mouse, an output device such as a display, and a communication device such as NIC (Network Interface Card).

Referring to the block diagram in FIG. 6, the mobile information device 150 includes a transmitting and receiving unit 151, a storage unit 152, a display and operation unit 153, and a control unit 154.

The transmitting and receiving unit 151 functions as a transmitting unit (a third transmitting unit) that transmits data and a receiving unit (a third receiving unit) that receives data. For example, the transmitting and receiving unit 151 may be connected to the Internet 172, and may transmit data to and receive data from the Internet 172. The transmitting and receiving unit 151 may be, for example, a wireless communication device.

The storage unit 152 stores information needed in processing by the mobile information device 150.

The display and operation unit 153 functions as an operation unit that accepts operations from the user of the mobile information device 150, and as a display unit that displays screens. Specifically, the display and operation unit 153 functions as a designating unit for designating printing data that a printer 110 is to print. The display and operation unit 153 also functions as a display unit that displays a display screen listing the printers 110, so that the printer 110 that is to print the printing data can be selected. The display and operation unit 153 also functions as an accepting unit that accepts the selection, from the list displayed on the screen, of the printer 110 that is to perform the printing.

By controlling the above units, the control unit 154 carries out processes in the mobile information device 150. For example, the control unit 154 communicates with the cloud server 130 and has the printers 110 carried out the printing.

The mobile information device 150 described above may be implemented by a computer incorporating a CPU, a memory, an external storage device such as HDD (Hard Disk Drive), an input device, an output device such as a display, and a communication device.

Next the operation of the embodiment will be described.

First, the administrator of the printers 110 stores user list information 112a (FIG. 3) in the storage unit 112 of a printer 110.

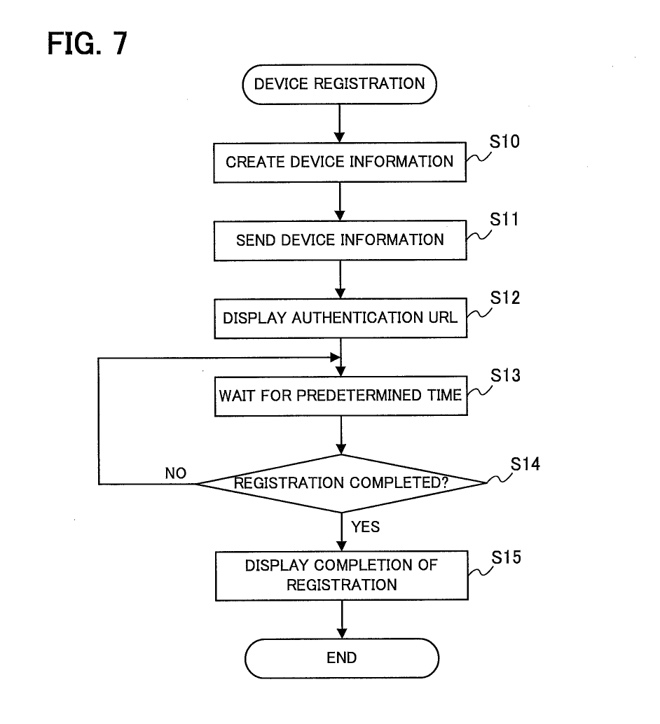

The process of registering a printer 110 in the cloud server 130 is illustrated in the flowchart in FIG. 7. The process in FIG. 7 begins when the administrator enters an instruction on the display and operation unit 115 of the printer 110 to register the printer 110 in the cloud server 130.

First, the control unit 116 in the printer 110 creates device information 180 as shown in FIG. 4 (S10). By registering this information in the cloud server 130, it becomes possible to designate a user at the time of printing.

Next, the control unit 116 has the transmitting and receiving unit 111 send the prepared device information 180 to the cloud server 130 (S11).

When the cloud server 130 receives the device information 180, the control unit 133 checks the device information 180 for mistakes in its items. If there are no mistakes, the control unit 133 has the transmitting and receiving unit 131 send the printer 110 an authentication URL for access to an HTML page for completing the registration process.

When the printer 110 receives this authentication URL, the control unit 116 displays the received authentication URL on the display and operation unit 115 (S12). The control unit 116 then waits for a predetermined time (S13).

At this point the user, referring to the authentication URL displayed on the display and operation unit 115 of the printer 110, accesses the authentication URL of the cloud server 130 from the mobile information device 150. The display and operation unit 153 of the mobile information device 150 displays the HTML page accessed by the authentication URL and waits for the user to enter, for example, an account and mail address. The control unit 154 in the mobile information device 150 then has the transmitting and receiving unit 151 send the entered account and mail address to the cloud server 130. When this information is sent to the cloud server 130, the control unit 133 in the cloud server 130 completes the registration process by storing the printer name and printer ID included in the device information 180 sent from the printer 110 being registered and the newly sent account and mail address in association with each other in the management information.

Then the control unit 116 in the printer 110 checks the registration status in the cloud server 130 through, for example, the transmitting and receiving unit 111 (S14). If registration has been successfully completed (Yes in step S14), the process proceeds to step S15. If registration has not been successfully completed (No in step S14), the process returns to step S13.

In step S15, the control unit 116 has the display and operation unit 115 display a screen indicating that registration has been completed.

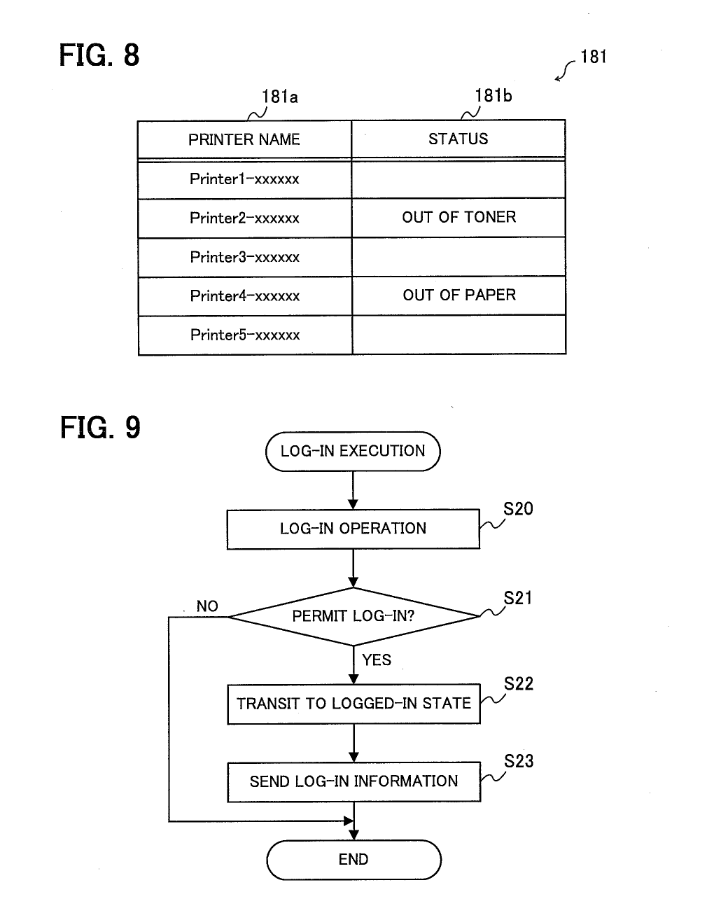

When there are a plurality of printers 110, a plurality of printers 110 can be registered in the cloud server 130 by executing the process in FIG. 7 for each printer 110. FIG. 8 shows an exemplary printer list screen that the mobile information device 150 can refer to when five printers have been registered. The printer list screen 181 in FIG. 8 has a printer name display area 181a and a status display area 181b. The printer names of all the printers 110 registered in association with the account and mail address of the user of the mobile information device 150 are displayed in the printer name display area 181a. The status of each printer 110 named in the printer name display area 181a is displayed in the status display area 181b. When an error such as running out of paper or toner has occurred in a printer, that information is displayed as the printer's status.

Next the operation of the system when the mobile information device 150 is used to have a printer 110 execute printing will be described with reference to FIGS. 9 to 13.

The flowchart in FIG. 9 illustrates the process of logging into the printer 110.

First the user performs the log-in operation by entering his or her user name and password on the display and operation unit 115 of the printer 110 with which the user wants to print (S20).

The control unit 116 in the printer 110 decides whether or not to permit the log-in by comparing the entered user name and password with the user names and passwords stored in the user list information 112a in the storage unit 112 (S21). If the control unit 116 decides to permit the log-in (Yes in step S21), the process proceeds to step S22. If the control unit 116 decides not to permit the log-in (No in step S21), the control unit 116 leaves the printer 110 in the logged-out state and the process ends.

In step S22, the control unit 116 sets the printer 110 to the logged-in state. In the logged-in state, the user can execute printing with the printer 110.

Next, the control unit 116 generates log-in information as operation information including the printer name and device ID of the printer 110, the information indicating that the log-in operation has been performed, and the user name of the user who logged in, and has the transmitting and receiving unit 111 send this information to the cloud server 130 (S23). If the user name of the user who logged in is ‘User A’, for example, then the log-in information generated in step S23 includes the character string ‘User A logged in’.

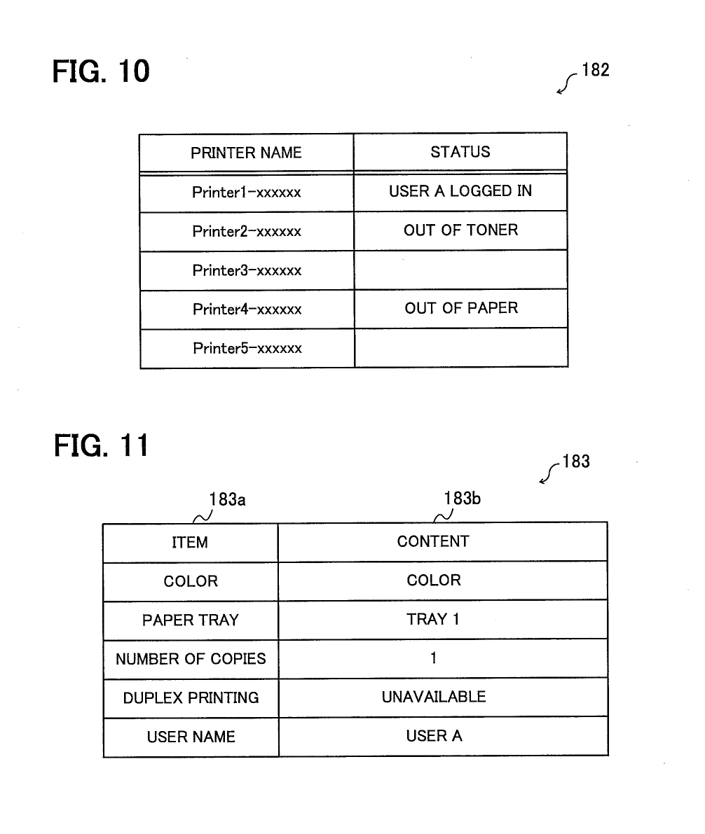

When the log-in information arrives at the cloud server 130, the control unit 133 receives the log-in information from the transmitting and receiving unit 131. In the status management information stored in the storage unit 132, the control unit 133 updates the status associated with the printer name and device ID included in the received log-in information to indicate the status resulting from the operation indicated in the received log-in information (in this case, ‘User A logged in’). In this state, if the user logs into the cloud server 130 from the mobile information device 150 and calls up the printer list display screen, a printer list screen 182 such as the one shown in FIG. 10 is displayed on the display and operation unit 153 of the mobile information device 150. If the user with user name ‘User A’ has logged into the printer 110 with printer name ‘Printer1-xxxxxx’, then ‘User A logged in’ is displayed as the status of printer name ‘Printer1-xxxxxx’ as in the printer list screen 182 shown in FIG. 10. The user can therefore easily identify the printer 110 into which he or she is logged in from among the plurality of printers 110.

This type of printer list screen 182 is created by the control unit 133 in the cloud server 130 on the basis of the management information and status information stored in the storage unit 132. The control unit 154 in the mobile information device 150 can display this screen on the display and operation unit 153 by using a browser, for example, to acquire the screen data necessary to display this screen from the cloud server 130.

Next, the user designates the file to be printed on the display and operation unit 153 of the mobile information device 150, selects the logged-in printer, and gives the command to print. In this process the control unit 154 in the mobile information device 150 may use a browser, for example, to get screen data for displaying a list of printing data stored in the storage unit 132 in the cloud server 130, display this list on the display and operation unit 153, and accept a file selection command. This list display screen is also created by the control unit 133 in the cloud server 130, on the basis of the printing data stored in the storage unit 132.

When giving the printing command, the user also selects settings from among the printing settings supported by the selected printer 110. The control unit 133 in the cloud server 130 creates screen data for displaying a selection screen for the printing settings on the basis of the device information 180 sent from the printer 110 to the cloud server 130 when the printer 110 was registered, and has the transmitting and receiving unit 131 send the screen data to the mobile information device 150. The display and operation unit 153 in the mobile information device 150 displays the printing setting selection screen, and accepts selections from the user. When the user has selected the printing settings, according to the selected printing settings, the control unit 133 in the cloud server 130 generates printing setting information 183 of the type shown in FIG. 11.

The printing setting information 183 shown in FIG. 11 has an item column 183a and a content column 183b.

The item column 183a stores the item names of the printing settings. The items in the printing settings in this example are ‘color’, ‘paper tray’, ‘number of copies’, ‘duplex printing’ and ‘user name’.

The content column 183b stores the content (values) corresponding to the items identified in the item column 180a. The content of the ‘color’, ‘paper tray’, ‘number of copies’, and ‘duplex printing’ items gives instructions as to how the printing is to be done. The content of the ‘user name’ item is the user name of the user who entered the printing command. Specifying this user name enables the printer 110 to identify the user at the time of printing.

The control unit 133 in the cloud server 130 then generates a printing job including the designated printing data and the generated printing setting information 183, and stores it in the storage unit 132.

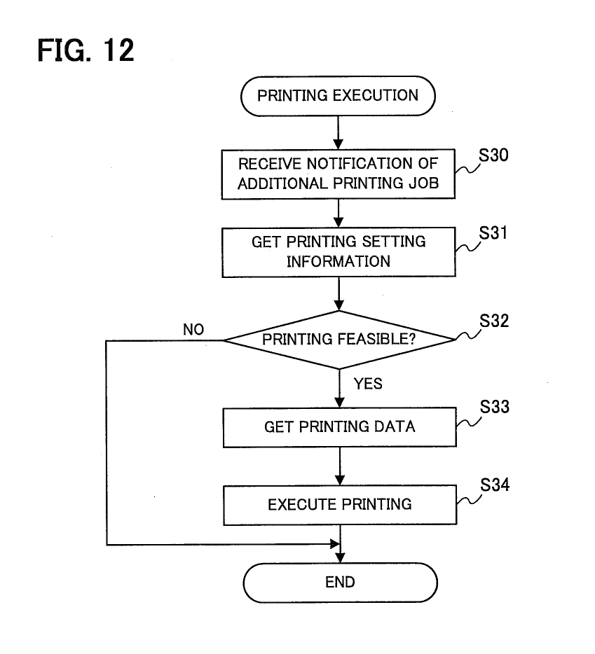

The process carried out when the printer 110 executes the printing job is illustrated by the flowchart in FIG. 12. When the print command is given at the mobile information device 150, the control unit 133 in the cloud server 130 notifies the printer 110 through the transmitting and receiving unit 131 that a printing job has been added.

The transmitting and receiving unit 111 in the printer 110 receives this notification (S30). The notification is passed from the transmitting and receiving unit 111 to the control unit 116. To carry out printing according to this notification, the control unit 116 acquires the printing setting information 183 included in the printing job from the cloud server 130 via the transmitting and receiving unit 111 (S31).

Next, the control unit 116 compares the acquired printing setting information 183 with the user list information 112a stored in the storage unit 112 and decides whether or not printing is feasible (S32). For example, the control unit 116 identifies a record in which the user name included in the acquired printing setting information 183 is stored in the user name column 112b. Then the control unit 116 decides whether or not printing is feasible by deciding whether or not printing can be executed with the content of the items shown in the acquired printing setting information 183 by a printing method permitted in the permission information column 112d in the identified record. If printing is feasible (Yes in S32), the process proceeds to step S33. If printing is not feasible (No in S32), the control unit 116 causes the display and operation unit 153 to display a notice that it was unable to print the job, and terminates the process.

In step S33, the control unit 116 in the printer 110 acquires the printing data included in the printing job from the cloud server 130 through the transmitting and receiving unit 111, and stores the printing data in the storage unit 112.

The control unit 116 then gives commands to the image processing unit 113 and printing unit 114 to execute the printing process (S34). For example, the image processing unit 113 converts the printing data stored in the storage unit 112 on the basis of the printing setting information 183 stored in the storage unit 112 and generates data for use in printing. The printing unit 114 prints by forming an image on a printing medium on the basis of the data for use in printing.

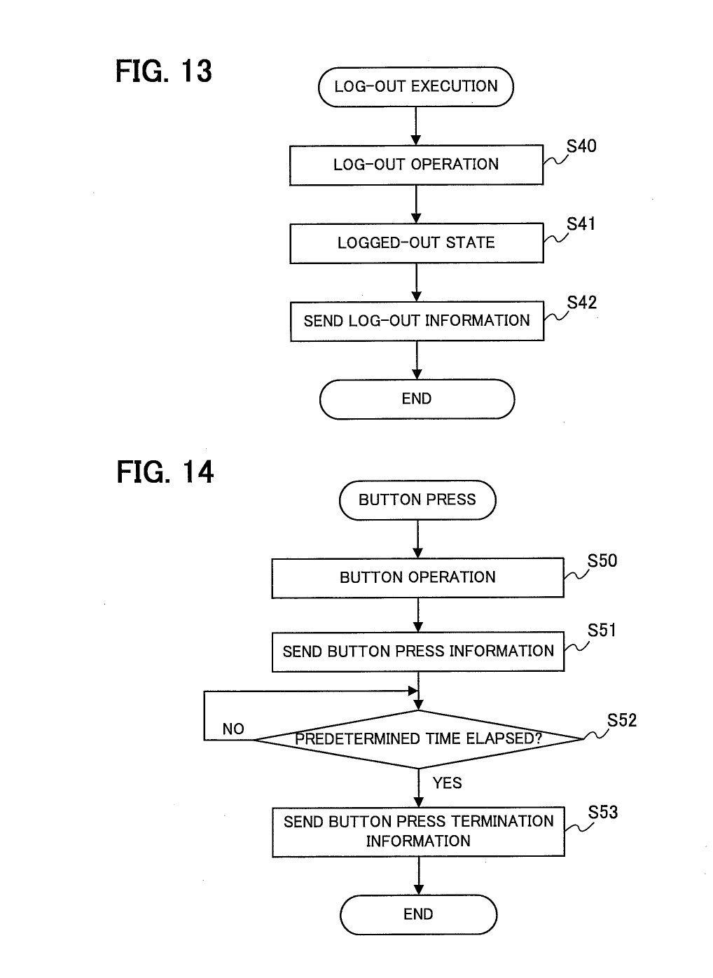

The flowchart in FIG. 13 illustrates the process carried out when a log-out operation is performed on the printer 110.

First, the user logs out by entering a log-out operation on the display and operation unit 115 of the printer 110 to which he or she is logged in (S40).

The control unit 116 in the printer 110 then places the printer 110 in the logged-out state (S41). In the logged-out state, the user cannot have printing executed by the printer 110.

Next, the control unit 116 generates log-out information as operation information including information indicating that the log-out operation has been performed and including the printer name and device ID of the printer 110, and has the transmitting and receiving unit 111 send this information to the cloud server 130 (S42).

When the log-out information arrives at the cloud server 130, the control unit 133 receives the log-in information from the transmitting and receiving unit 131. In the status management information stored in the storage unit 132, the control unit 133 deletes the status associated with the printer name and device ID included in the received log-out information. In this state, if the user logs into the cloud server 130 from the mobile information device 150 and calls up the printer list screen, a printer list screen 181 like the one shown in FIG. 8 is displayed; the ‘User A logged in’ status indicated in the printer list screen 182 shown in FIG. 10 has been removed.

In the non-limiting example described in the embodiment above, when the user logs in, operation information (log-in information) is sent to the cloud server 130 and a screen on which the printer 110 for which the log-in operation was performed out can be identified is displayed on the mobile information device 150. To give another example, when the user presses a button, corresponding operation information may be sent to the cloud server 130, and a screen on which the printer 110 on which the button operation was performed can be identified may be displayed on the mobile information device 150.

The process carried out when a button operation is performed on the printer 110 is illustrated by the flowchart in FIG. 14.

First the user performs the button operation by pressing a predetermined button on the display and operation unit 115 of the printer 110 with which the user wants to print (S50).

Next, as operation information, the control unit 116 generates button press information including the printer name and device ID of the printer 110 and information indicating that the button has been pressed, and has the transmitting and receiving unit 111 send this information to the cloud server 130 (S51).

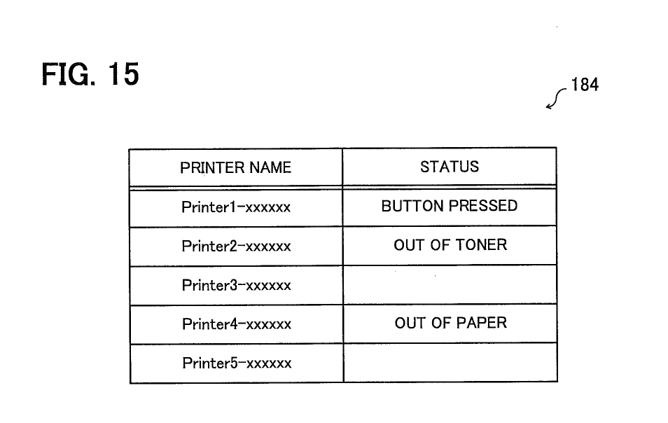

When the button press information arrives at the cloud server 130, the control unit 133 receives the button press information from the transmitting and receiving unit 131. In the status management information stored in the storage unit 132, the control unit 133 updates the status associated with the printer name and device ID included in the received button press information to indicate the status indicated in the received button press information (for example, the button pressed state). In this state, if the user logs into the cloud server 130 from the mobile information device 150 and calls up the printer list display screen, a printer list screen 181 such as the one shown in FIG. 8 is displayed on the display and operation unit 153 of the mobile information device 150. If the user pressed the button on the printer 110 with printer name ‘Printer1-xxxxxx’, then ‘Button pressed’ is displayed as the status of printer name ‘Printer1-xxxxxx’ as in the printer list display screen 184 shown in FIG. 15. The user can therefore easily identify the printer 110 on which he or she pressed a button from among the plurality of printers 110.

Returning to the description of FIG. 14, in step S52 the control unit 116 in the printer 110 decides whether or not a predetermined time has elapsed from the pressing of the button, and proceeds to step S53 when this time has elapsed.

In step S53, the control unit 116 generates, as operation termination information, button press termination information including the printer name and device ID of the printer 110 and information indicating the termination of the button press, and has the transmitting and receiving unit 111 send this button press termination information to the cloud server 130.

When the button press termination information arrives at the cloud server 130, the control unit 133 receives the button press termination information from the transmitting and receiving unit 131. In the status management information stored in the storage unit 132, the control unit 133 deletes the status associated with the printer name and device ID included in the received button press termination information. In this state, if the user logs into the cloud server 130 from the mobile information device 150 and calls up the printer list screen, a printer list screen 181 like the one shown in FIG. 8 is displayed; the ‘Button pressed’ status indicated in the printer list display screen 184 shown in FIG. 15 has been removed.

The log-in operation indication and button press indication described above may be combined. For example, the button press indication may be displayable until the log-in operation is performed on the printer 110; then when the log-in operation is performed, the logged-in indication may be displayed as the status of the printer 110 until the log-out operation is performed. Alternatively, the button press indication may be displayable until the log-in operation is performed on the printer 110; then when the log-in operation is performed, the logged-in indication may be displayed as the status of the printer 110 until the log-out operation is performed, and if the button is pressed during this time, the button press indication may be added to the logged-in indication.

When a button press indication is displayed, button identification information (for example, the name of the button) may also be displayed to enable the button that was pressed to be identified. This can be done by including the button identification information of the button that was pressed in the button press information.

In the description above the log-in and button press indications were made by use of character strings, but these are non-limiting examples. Instead of character strings, a symbol such as an icon may be displayed to indicate a log-in or the pressing of a button, or the printer name of the printer 110 on which the log-in operation or button press was carried out may be caused to blink or may be displayed in a different color to make it known that an operation has been carried out.

The control unit 116 in the printer 110 may place location information indicating the location of the printer 110 in the operation information, and the location of the printer 110 may also be displayed on the list display screen. The installation location of the printer 110, for example, or the name of the department in which the printer 110 is installed may be used as the location information, to make it easy to tell where the printer 110 is located.

In the embodiment described above, the log-in operation was performed on the display and operation unit 115 of the printer 110, but this is another non-limiting example. If, for example, a smart card reader is connected to the printer 110, the log-in operation may be performed by enabling the smart card reader to read a smart card in which the information necessary for log-in is stored. In this case, when the smart card has been placed in a state in which it is readable by the smart card reader, the control unit 116 in the printer 110 may send the cloud server 130 operation information (for example, smart card read information) indicating that the smart card has been read, and the reading of the smart card may be indicated as status information. When the smart card is removed from the smart card reader, the control unit 116 in the printer 110 may send the cloud server 130 operation information indicating the termination of the reading of the smart card (smart card read termination information), and the smart card read status information may be deleted.

In the embodiment described above, the log-in operation was carried out on the display and operation unit 115 of the printer 110, but this is yet another non-limiting example. If the printer is equipped with communication facilities (a communication unit) enabling it to send information to and receive information from a mobile information device, for example, then the log-in operation may be carried out by communication between these facilities and the mobile information device. The information necessary for the log-in operation may be prestored in the mobile information device, or the information necessary for the log-in operation may be input from the operation unit of the mobile information device. In this case, while the printer's communication facilities are communicating with the mobile information device, the control unit 116 in the printer 110 may send the cloud server 130 operation information indicating the in-communication state (in-communication information, for example), and cause an in-communication indication to be displayed. When communication is terminated, the control unit 116 in the printer 110 may remove the in-communication status indication by sending the cloud server 130 operation information indicating the termination of communication (communication termination information, for example).

In the embodiment described above, printing data were stored in the storage unit 132 of the cloud server 130, but this is still another non-limiting example. The printing data may be stored in the storage unit 152 of the mobile information device 150, for example. In that case, after receiving a designation of the data to be printed, the control unit 154 in the mobile information device 150 may send the designated printing data to the cloud server 130 via the transmitting and receiving unit 151. The mobile information device 150 may then use an application program designed for cloud printing, instead of a browser, to open the printing data, and give the printing command to that application program.

The embodiment described above makes the printer 110 on which printing is to be executed easily identifiable, even when a plurality of printers are registered in the cloud server 130.

The exemplary image forming devices used in the embodiment described above are printers 110, but this is not a limitation. They may be copiers, multifunction printers (MFPs), facsimile (fax) machines, or other such devices.

In the embodiment described above, the transmitting and receiving unit 131 in the cloud server 130 receives operation information sent from a printer 110, but this arrangement is also exemplary and not limiting. For example, the transmitting and receiving unit 131 in the cloud server 130 may receive an identifying signal indicating one of the plurality of printers 110 from an external source, and the control unit 133 may generate screen data for displaying a list of printers 110 including the indicated printer 110. When the mobile information device 150 receives this type of screen data, on the basis of the screen data received by the transmitting and receiving unit 151, the display and operation unit 153 of the mobile information device 150 displays a screen listing the printers 110 so that the printer 110 that is to carry out printing can be selected. This list display screen includes an indication by which the printer 110 indicated by the identifying signal can be identified. The identifying signal may be sent to the cloud server 130 from, for example, the mobile information device 150. In that case, the display and operation unit 153 accepts a selection of one printer 110 from among the plurality of printers 110, the control unit 154 generates an identifying signal indicating the selected printer 110, and the transmitting and receiving unit 151 sends the generated identifying signal to the cloud server 130. Alternatively, the identifying signal may be sent to the cloud server 130 from an information processing device such as a personal computer (not shown). The information processing device has a printer selection unit for selecting one printer from among the plurality of printers 110, an identifying signal generating unit for generating an identifying signal indicating the printer selected by the printer selection unit, and a transmitting unit (a fourth transmitting unit) for sending the identifying signal generated by the identifying signal generating unit to the cloud server 130.

Those skilled in the art will recognize that further variations are possible within the scope of the invention, which is defined in the appended claims.

What is claimed is:

1. An image forming system including a plurality of image forming devices, a management server, and an information processing device, wherein:
each one of the plurality of image forming devices comprises
an operation unit for accepting an operation,
a first control unit for generating operation information indicating that the operation accepted by the operation unit has been carried out, and
a first transmitting unit for sending the operation information generated by the first control unit to the management server;
the management server comprises
a second receiving unit for receiving the operation information sent from the first transmitting unit,
a second control unit for generating screen data for a list display screen listing the plurality of image forming devices, the list display screen including a displayed indication that the operation indicated by the operation information has been carried out on the image forming device from which the operation information was sent, and
a second transmitting unit for sending the screen data generated by the second control unit to the information processing device;
the information processing device comprises
a designating unit for designating image forming data,
a third receiving unit for receiving the screen data sent from the second transmitting unit,
a display unit for displaying the list display screen on a basis of the screen data received by the third receiving unit, and
an accepting unit for accepting a selection that selects, from the list display screen, an image forming device to form an image based on the image forming data designated by the designating unit;
the second transmitting unit sends the image forming data designated by the designating unit to the image forming device selected by the accepting unit; and
each one of the plurality of image forming devices further comprises
a first receiving unit for receiving the image forming data sent from the second transmitting unit, and
an image forming unit for forming an image based on the image forming data received by the first receiving unit.

2. The image forming system of claim 1, wherein the operation is a log-in operation.

3. The image forming system of claim 2, wherein:
the operation unit accepts input of user identification information for identifying a user in the log-in operation;
the first control unit includes the user identification information, input of which was accepted by the operation unit, in the operation information; and
the second control unit includes, in the list display screen, an indication showing that the operation indicated by the operation information has been performed, by the user identified by the user identification information included in the operation information, on the image forming device that sent the operation information.

4. The image forming system of claim 1, wherein the operation unit has a button and the operation is performed by pressing the button.

5. The image forming system of claim 4, wherein:
the first control unit includes, in the operation information, button identification information for identifying the button that was pressed; and
the second control unit includes, in the list display screen, an indication that the button identified by the button identification information included in the operation information has been pressed on the image forming device that sent the operation information.

6. An image forming system including a plurality of image forming devices, a management server, and an information processing device, wherein:
the management server comprises
a second receiving unit for receiving, from an external source, an identifying signal indicating one of the plurality of image forming devices,
a second control unit for generating screen data for a list display screen listing the plurality of image forming devices, including the image forming device indicated by the identifying signal received by the second receiving unit, and
a second transmitting unit for sending the screen data generated by the second control unit to the information processing device;
the information processing device comprises
a designating unit for designating image forming data,
a third receiving unit for receiving the screen data sent from the second transmitting unit,
a display unit for displaying the list display screen on a basis of the screen data received by the third receiving unit, and
an accepting unit for accepting a selection that selects, from the list display screen, an image forming device to form an image based on the image forming data designated by the designating unit;
the second transmitting unit sends the image forming data designated by the designating unit to the image forming device selected by the accepting unit; and
each one of the plurality of image forming devices comprises
a first receiving unit for receiving the image forming data sent from the second transmitting unit, and
an image forming unit for forming an image based on the image forming data received by the first receiving unit.

7. An image forming device for use in an image forming system including a management server and an information processing device, the image forming device comprising:
an operation unit for accepting an operation;
a control unit for generating operation information indicating that the operation accepted by the operation unit has been carried out;
a transmitting unit for sending the operation information generated by the control unit to the management server;
a receiving unit for receiving image forming data designated by the information processing device and sent from the management server when the image forming device is selected by the information processing device from a list display screen including a displayed indication indicating that the operation indicated by the operation information has been performed on the image forming device, from which the operation information has been sent; and
an image forming unit for forming an image based on the image forming data received by the receiving unit.
